(19) United States
(12) Patent Application Publication
(10) Pub. No.: US 2024/0428774 A1
(43) Pub. Date: Dec. 26, 2024

(54) COGNITIVE ASSISTANT VOICE AMELIORATION MODEL

(71) Applicant: International Business Machines Corporation, Armonk, NY (US)

(72) Inventors: Kelley Anders, East New Market, MD (US); Jonathan D. Dunne, Dungarvan (IE)

(21) Appl. No.: 18/338,432

(22) Filed: Jun. 21, 2023

(51) Int. Cl. G10L 13/033; G10L 13/10

(52) U.S. Cl. CPC G10L 13/033; G10L 13/10

(57) ABSTRACT

According to one embodiment, a method, computer system, and computer program product for augmenting a digital audio representation of a voice is provided. The embodiment may include identifying a current voice waveform of a user. The current voice waveform corresponds to captured speech output of the user. The embodiment may include comparing one or more frequency components of the current voice waveform to one or more corresponding frequency components of a baseline voice waveform of the user. In response to determining that at least one of the one or more frequency components of the current waveform fail a threshold degree of match to at least one corresponding frequency component of the baseline voice waveform, the embodiment may include augmenting the captured speech output via a generative artificial intelligence (AI) voice model trained to produce speech which mimics a voice and a speaking style of the user.

### BACKGROUND

The present invention relates generally to the field of computing, and more particularly to generative artificial intelligence (AI) voice technology.

Generative AI voice technology, also known as text-to-speech (TTS) synthesis or speech synthesis, refers to the use of artificial intelligence techniques to generate human-like speech from text input. It involves training models to understand and convert written text into natural-sounding spoken words. Generative AI voice technology typically uses deep learning architectures such as recurrent neural networks (RNNs) or transformer-based models to learn patterns and relationships between text input and corresponding speech output. When presented with a text input, a generative AI voice model processes the text and generates a corresponding audio waveform that represents synthesized speech of the text input. Such models are trained on large datasets of text and speech pairs, allowing them to learn the complex relationships between linguistic features and corresponding acoustic representations (i.e., to learn the nuances of human speech, including intonation, cadence, and pronunciation). Once trained, generative AI voice models can convert text input into high-quality speech in a variety of languages and voices. Further, these models can also be fine-tuned or conditioned to mimic specific voices or speaking styles, resulting in more natural and expressive voices.

### SUMMARY

According to one embodiment, a method, computer system, and computer program product for augmenting a digital audio representation of a voice is provided. The embodiment may include identifying a current voice waveform of a user. The current voice waveform corresponds to captured speech output of the user. The embodiment may include comparing one or more frequency components of the current voice waveform to one or more corresponding frequency components of a baseline voice waveform of the user. In response to determining that at least one of the one or more frequency components of the current waveform fail a threshold degree of match to at least one corresponding frequency component of the baseline voice waveform, the embodiment may include augmenting the captured speech output via a generative artificial intelligence (AI) voice model trained to produce speech which mimics a voice and a speaking style of the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for initializing a cognitive voice amelioration system via a cognitive voice amelioration initialization process according to at least one embodiment.

FIG. 3 illustrates an operational flowchart for mitigating suboptimal conditions of a digital audio representation of a user's voice via a cognitive voice amelioration process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may,
however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to generative AI voice technology. The following described exemplary embodiments provide a system, method, and program product to, among other things, supplement a digital waveform representation of a user's speech, which is transmitted via a network, based on comparison to a baseline waveform representation of the user's speech and current conditions of the network. Therefore, the present embodiment has the capacity to improve the technical field of generative AI voice technology by dynamically augmenting a real-time waveform representation of a user's speech using a trained generative AI voice model during transmission of the real-time waveform representation via a network (e.g., during a web conference call), thus minimizing, or eliminating potential loss of clarity of the user's speech throughout transmission.

As previously described, generative AI voice technology refers to the use of artificial intelligence techniques to generate human-like speech from text input. It involves training models to understand and convert written text into natural-sounding spoken words. Generative AI voice technology typically uses deep learning architectures such as recurrent neural networks (RNNs) or transformer-based models to learn patterns and relationships between text input and corresponding speech output. When presented with a text input, a generative AI voice model processes the text and generates a corresponding audio waveform that represents synthesized speech of the text input. Such models are trained on large datasets of text and speech pairs, allowing them to learn the complex relationships between linguistic features and corresponding acoustic representations (i.e., to learn the nuances of human speech, including intonation, cadence, and pronunciation). Once trained, generative AI voice models can convert text input into high-quality speech in a variety of languages and voices. Further, these models can also be fine-tuned or conditioned to mimic specific voices or speaking styles, resulting in more natural and expressive voices.

Generative AI voice technology may be useful in numerous of applications. For instance, the ability of a generative AI voice model to mimic a specific voice or speaking style may allow for personalized voice-overs and audio dubbing, as well as personalized augmentation and/or substitution of a user's speech utterance data. Consider a scenario in which a user is participating in an online conference call and is speaking during the call. For a variety of reasons, the quality (e.g., clarity, volume, background noise) of the user's speech, as received by other participants of the conference call, may be deficient and result in poor reception of the user's speech. For example, the user may be experiencing some illness which adversely affects their voice, or the user may be participating in the conference call from an area with low internet bandwidth, or their internet connection may be experiencing high packet loss or latency. It may therefore be imperative to have a cognitive voice amelioration system in place to identify when a user's speech output is suboptimal and, accordingly, augment utterances of the user during a web conference via a generative AI voice model trained on the user's speech characteristics. Thus, embodiments of the present invention may be advantageous to, among other things, utilize deep learning to train and calibrate a generative AI voice model on user-specific training material which includes audio data (e.g., speech utterances) and corresponding text transcriptions, perform spectral analysis on user-specific training material to identify baseline voice waveform frequency metrics (collectively referred to as a baseline waveform) of a user, identify an optimal baseline waveform of a user, perform a microphone performance test and a network connection test of a user's computing device before participation in a web conference call by the user via the computing device, identify, at least periodically, voice waveform frequency metrics of a user while participating in a web conference call, calculate one or more perceptual evaluation of speech quality (PESQ) scores for speech output of a user during a web conference call, perform, at least periodically during a web conference call, comparisons of identified voice waveform metrics of a user to a baseline voice waveform of the user, maintain a running transcript of a user's speech utterances while participating in a web conference call, augment, via a generative AI voice model trained to mimic a user's voice and speaking style, one or more voice waveform metrics and corresponding speech output of the user transmitted during a web conference call, substitute, via a generative AI voice model trained to mimic a user's voice and speaking style, one or more transmitted speech utterances of a user during a web conference call, and notify a user in real-time of any augmentation or substitution of their speech output while participating in a web conference call. The present invention does not require that all advantages need to be incorporated into every embodiment of the invention.

According to at least one embodiment, a cognitive voice amelioration program may train and calibrate an existing generative AI voice model using a corpus of user-specific training material. The user-specific training material may include a plurality of audio recordings and corresponding text transcriptions of a user. Once trained, the existing generative AI voice model may produce speech which mimics the voice and speaking style (e.g., cadence, volume, tone, inflection, etc.) of the user. According to at least one embodiment, the cognitive voice amelioration program may perform spectral analysis (e.g., using spectrograms) to identify a baseline voice waveform of the user. The baseline voice waveform may include a plurality of baseline waveform frequency metrics. According to at least one embodiment, in preparation for participation by the user in an online conference call via a computing device of the user, the cognitive voice amelioration program may evaluate network connectivity as well as microphone performance of the computing device. Further, during participation by the user in the online conference call, the cognitive voice amelioration program may, at least periodically, identify current voice waveform frequency metrics (i.e., a current voice waveform) of the user and compare the identified current voice waveform frequency metrics with the baseline voice waveform of the user. According to at least one embodiment, in response to a difference between the user's current voice waveform being transmitted during the online conference call and the user's baseline voice waveform exceeding a threshold value, the cognitive voice amelioration program may augment, via the trained existing generative AI voice model, one or more segments of speech output corresponding to the user's current voice waveform being transmitted during the web conference call.

According to at least one other embodiment, in response to a difference between the user's current voice waveform being transmitted during the online conference call and the user's baseline voice waveform exceeding a threshold value, the cognitive voice amelioration program may augment, via the trained existing generative AI voice model, one or more frequency metrics of the user's current voice waveform frequency metrics being transmitted during the web conference call. According to at least one further embodiment, in response to an evaluation of network connectivity and/or microphone performance of the computing device falling below a threshold value, the cognitive voice amelioration program may augment, via the trained existing generative AI voice model, one or more frequency metrics of the user's current voice waveform and/or one or more segments of speech output corresponding to the user's current voice waveform being transmitted during the web conference call.

According to yet another embodiment, the cognitive voice amelioration program may identify an optimal voice waveform of the user and align a current voice waveform of the user with the optimal voice waveform when augmenting one or more metrics of the user's current voice waveform and/or one or more segments of speech output corresponding to the user's current voice waveform being transmitted during the web conference call. According to yet one further embodiment, in response to a difference between the user's current voice waveform being transmitted during the online conference call and the user's baseline voice waveform exceeding a threshold value or in response to an evaluation of network connectivity and/or microphone performance of the computing device falling below a threshold value, the cognitive voice amelioration program may substitute speech of the user during the online conference call via the trained existing generative AI voice model. In such an embodiment, the cognitive voice amelioration program may receive text input from the user and utilize the trained existing generative AI voice model to perform text-to-speech (TTS) output in the voice and speaking style of the user.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to detect a degradation in audio quality of a user's transmitted speech data while participating in an online conference call and, accordingly, augment the user's transmitted speech data using a generative AI voice model trained to mimic the user's voice and speaking style.

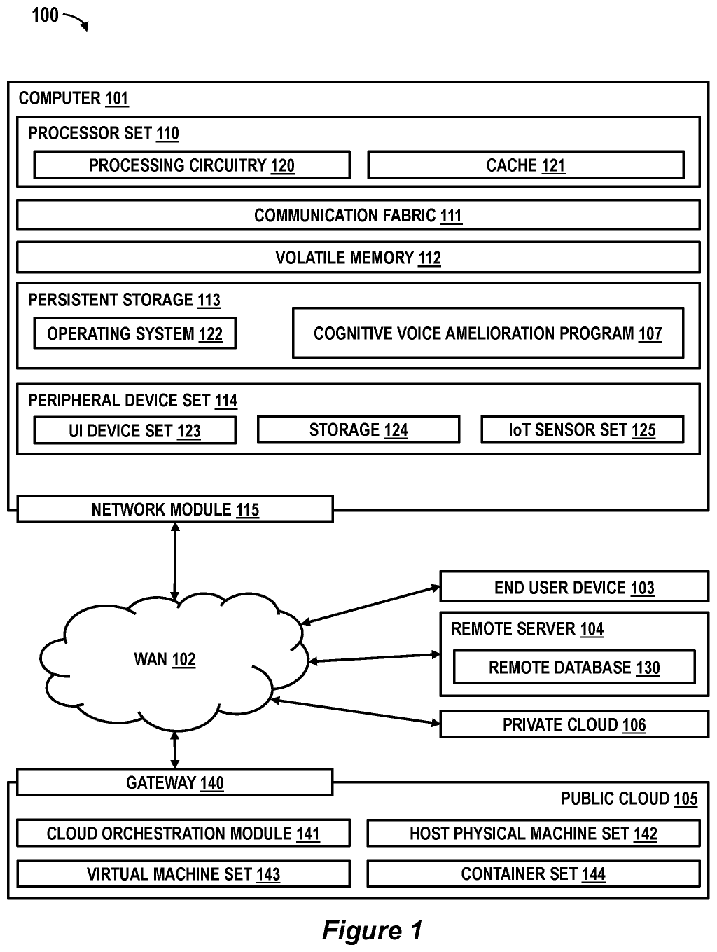

Referring to FIG. 1, an exemplary computing environment 100 is depicted, according to at least one embodiment. Computing environment 100 contains an example of an environment for the execution of at least some of the computer code involved in performing the inventive methods, such as cognitive voice amelioration (CVA) program 107. In addition to CVA program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CVA program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smart watch or other wearable computer, mainframe computer, quantum computer or any other form of computer or mobile device now known or to be developed in the future that is capable of running a program and accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in CVA program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in CVA program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smart watches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a microphone, another sensor may be a motion detector, another sensor may be a global positioning system (GPS) receiver, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

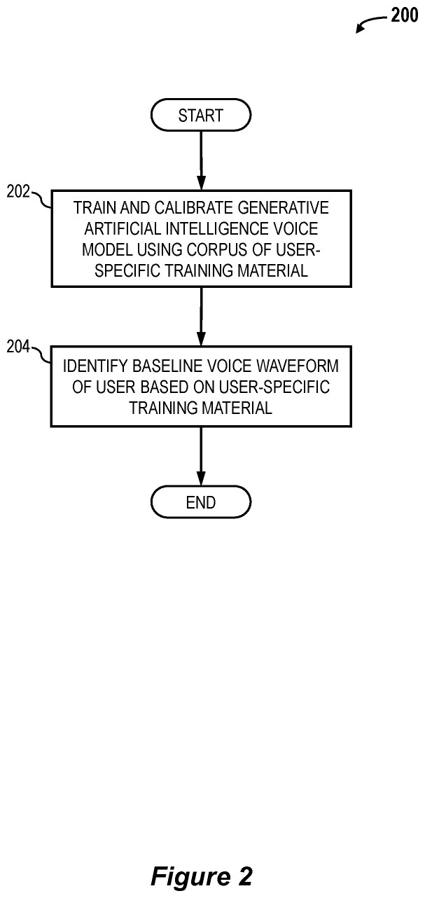

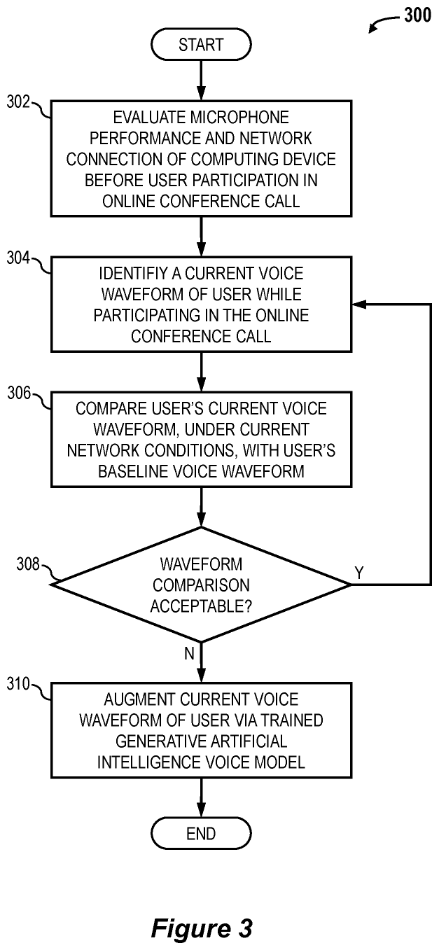

The CVA program 107 may be a program capable of utilizing deep learning to train and calibrate a generative AI voice model on user-specific training material which includes audio data (e.g., speech utterances) and corresponding text transcriptions, performing spectral analysis on user-specific training material to identify baseline voice waveform frequency metrics (collectively referred to as a baseline waveform) of a user, identifying an optimal baseline waveform of a user, performing a microphone performance test and a network connection test of a user's computing device before participation in a web conference call by the user via the computing device, identifying, at least periodically, voice waveform frequency metrics of a user while participating in a web conference call, calculating one or more perceptual evaluation of speech quality (PESQ) scores for speech output of a user during a web conference call, performing, at least periodically during a web conference call, comparisons of identified voice waveform metrics of a user to a baseline voice waveform and/or an optimal baseline waveform of the user, maintaining a running transcript of a user's speech utterances while participating in a web conference call, augmenting, via a generative AI voice model trained to mimic a user's voice and speaking style, one or more voice waveform metrics and corresponding speech output of the user transmitted during a web conference call, substituting, via a generative AI voice model trained to mimic a user's voice and speaking style, one or more transmitted speech utterances of a user during a web conference call, and notifying a user in real-time of any augmentation or substitution of their speech output while participating in a web conference call. In at least one embodiment, CVA program 107 may require a user to opt-in to system usage upon opening or installation of CVA program 107. Notwithstanding depiction in computer 101, CVA program 107 may be stored in and/or executed by, individually or in any combination, end user device 103, remote server 104, public cloud 105, and private cloud 106 so that functionality may be separated among the devices. Furthermore, while CVA program 107 is depicted as a stand-alone application, CVA program may also be implemented as a plug-in to a generative AI voice software application, an online conference software application, or any voice analysis software application. The cognitive voice amelioration method is explained in further detail below with respect to FIGS. 2 and 3.

Referring now to FIG. 2, an operational flowchart for initializing a cognitive voice amelioration system via a cognitive voice amelioration initialization process 200 is depicted according to at least one embodiment. At 202, CVA program 107 trains and calibrates an existing generative AI voice model using a corpus of user-specific training material which includes a plurality of audio recordings and corresponding text transcriptions of a particular user. According to at least one embodiment, as part of the training and calibration of the generative AI voice model, CVA program 107 may perform steps including data collection, data preprocessing, text alignment, model training, hyperparameter tuning, and evaluation. For example, CVA program 107 may gather or receive a substantial amount of audio data featuring the user's voice. Such data may include recordings of the user speaking various sentences, paragraphs, or a diverse range of texts. CVA program 107 may then clean and preprocess the gathered/received audio data to remove noise, normalize audio levels, and/or segment the audio data into smaller units for training. In furtherance of the example, CVA program 107 may align the text transcriptions corresponding to the audio recordings by pairing the textual content with the respective audio segments so that the generative AI voice model learns an association between the text and the user's voice. CVA program 107 may then utilize a deep learning model, such as a recurrent neural network (RNN) or a transformer-based model to train the generative AI voice model on the aligned text and audio data. CVA program 107 may calibrate the generative AI voice model through adjustments of the model's hyperparameters, such as learning rate, batch size, and architecture specifics to improve its performance and voice mimicry accuracy. Further, CVA program 107 may assess quality and fidelity of the model's generated voice output by evaluating it against reference audio samples or through received feedback of human listeners. Once trained, the existing generative AI voice model may produce speech which mimics the voice and speaking style (e.g., cadence, volume, tone, inflection, etc.) of the user. The corpus of user-specific training material and the generative AI voice model may be stored within storage 124 and/or remote database 130 and may be accessed (e.g., referenced, updated) by CVA program 107 during cognitive voice amelioration initialization process 200 and cognitive voice amelioration process 300, described below.

In an embodiment where CVA program 107 is implemented as a plug-in to an online conference software application or a voice analysis software application, training and calibration of the generative AI voice model may be facilitated through a user interface (UI) of the online conference software application or the voice analysis software application. For example, CVA program 107 may display a calibrate button in such a UI which enables calibration and allows the user to fine-tune the model's hyperparameters.

Next, at 204, CVA program 107 analyzes the corpus of user-specific training material to identify a baseline voice waveform of the user which includes a plurality of baseline waveform frequency metrics. According to at least one embodiment, in identifying the baseline voice waveform of the user, CVA program 107 may utilize existing spectral analysis techniques (e.g., spectrogram analysis) to process sound signals of the audio recordings within the user-specific training material into their individual frequency components (i.e., metrics). As sound typically comprises a complex waveform composed of multiple sine waves of different frequencies, amplitudes, and phases, the spectral analysis implemented by CVA program 107 may enable identification of a contribution of each individual frequency component to the overall sound signal. A resulting frequency-domain representation of an audio recording may be displayed, by CVA program 107, as a spectrogram which provides a detailed graph-based representation of frequency content of the audio recording over time. More specifically, a spectrogram represents frequency content of the audio recording on the y-axis, the time on the x-axis, and the intensity or magnitude of each frequency component as color or shading of the graph. According to at least one embodiment, CVA program 107 may perform a spectrogram analysis of all audio recordings within the user-specific training material, as such, the baseline voice waveform of the user may be a waveform which represents averages of individual frequency components within the user-specific training material. It should be noted that audio recordings within the user-specific training material may include speech recordings of the user while in an overall healthy physical condition (e.g., not experiencing an illness which adversely affects speaking ability) or speech recordings of the user while speaking in their normal voice, as perceived by the user. The identified baseline voice waveform of the user, as well as its corresponding spectrogram representation, may be stored within storage 124 and/or remote database 130 and may be accessed (e.g., referenced, updated) by CVA program 107 during cognitive voice amelioration initialization process 200 and cognitive voice amelioration process 300, described below.

According to at least one other embodiment, at 204, CVA program 107 may also identify an optimal voice waveform of the user based on generally accepted, or user defined, ranges of respective voice waveform frequency metrics. For instance, an optimal voice waveform of the user may include aligning one or more frequency components of the user's baseline voice waveform, such as pitch or volume, within generally accepted, or user defined, ranges of respective voice waveform frequency metrics.

Referring now to FIG. 3, an operational flowchart for mitigating suboptimal conditions of a digital audio representation of a user's voice via a cognitive voice amelioration process 300 is depicted according to at least one embodiment. At 302, CVA program 107 evaluates microphone performance and network connectivity of a computing device prior to participation by a user in an online conference call via the computing device. According to at least one embodiment, prior to the user's participation in the online conference call via their computing device (e.g., smartphone, laptop), CVA program 107 may test the capability of the device and its microphone to capture audio of the user (i.e., sound waves of the user's voice) and convert the captured audio into a digital signal. Additionally, prior to the user's participation in the online conference call, CVA program 107 may also test the computing device's network connection to identify metrics such as, but not limited to, network speed, bandwidth limitations, propagation delays (i.e., latency), bounded-size queues, network availability, jitter, packet loss, voice over internet protocol (VOIP) quality, and throughput. CVA program 107 may utilize existing open-source software tools for network evaluation.

According to at least one other embodiment, based on results of the microphone performance and network connections test, CVA program 107 may calculate an initial PESQ score to assess the quality of the user's voice prior to participation in the online conference. PESQ is a standardized objective measurement technique for assessing the quality of speech signals after undergoing network transmission or processing. PESQ scores are numerical values the perceived quality of a processed or transmitted speech signal. The scores typically range from −0.5 to 4.5, with higher values representing better perceived speech quality; this scale may be divided into several quality levels, such as excellent, good, fair, poor, and bad, based on the PESQ score ranges.

In an embodiment where CVA program 107 is implemented as a plug-in to an online conference software application, testing of a computing device's microphone performance and network connection may be facilitated through a UI of the online conference software application. For example, CVA program 107 may display a voice/network test button in such a UI which enables the evaluation of microphone performance and network connectivity by CVA program 107.

Next, at 304, CVA program 107 identifies a current voice waveform of the user while they are participating (i.e., speaking) in the online conference call. As noted above, a voice waveform may include a plurality of waveform frequency components (i.e., metrics). According to at least one embodiment, in identifying a current voice waveform of the user, CVA program 107 may perform spectrogram analysis on a segment of the user's speech captured by the microphone during their participation in the online conference call. The segment may include at least a portion of the user's most recently captured speech during the online call. According to at least one embodiment, when identifying a current voice waveform of the user, CVA program 107 may also identify current network metrics (i.e., perform a current network connection test) and calculate a current PESQ score corresponding to the current voice waveform of the user.

At 306, CVA program 107 compares the user's current voice waveform, and its corresponding current network metrics, to a baseline voice waveform of the user. According to at least one embodiment, the baseline voice waveform of the user may be the baseline voice waveform identified by CVA program 107 in cognitive voice amelioration initialization process 200 and stored within storage 124 and/or remote database 130. In performing the comparison, CVA program 107 may compare one or more waveform frequency components corresponding between the user's current voice waveform and the user's baseline voice waveform. Further, as part of the comparison, CVA program 107 may also compare the current PESQ score with the initial PESQ score and/or compare one or more of the current network metrics with one or more specified corresponding minimum network metric requirements.

Next, at 308, CVA program 107 determines whether the comparison of the user's current voice waveform to the user's baseline voice waveform is acceptable. According to at least one embodiment, a comparison may be unacceptable where CVA program 107 determines that one or more frequency components of the user's current waveform fail a threshold degree of match to corresponding frequency components of the user's baseline waveform (e.g., fall outside of an acceptable frequency range of the baseline waveform). According to at least one other embodiment, a comparison may also be unacceptable where CVA program 107 determines that one or more of the current network metrics fall below corresponding threshold values (e.g., a current network metric fails to meet a specified corresponding minimum network metric requirement). According to at least one further embodiment, a comparison may also be unacceptable where CVA program 107 determines that a difference between the current PESQ score and the initial PESQ score exceeds a threshold value or where the current PESQ score falls below a threshold value. In response to determining that the comparison of the user's current voice waveform to the user's baseline voice waveform is acceptable (step 308, “Y” branch), the cognitive voice amelioration process 300 may return to step 304. In response to determining that the comparison of the user's current voice waveform to the user's baseline voice waveform is not acceptable (step 308, “N” branch), the cognitive voice amelioration process 300 may proceed to step 310. It should be noted that at least steps 304-308 of process 200 may be performed, at least periodically, by CVA program 107 throughout the duration of the user's participation in the online conference call.

At 310, in response to determining that the comparison of the user's current voice waveform to the user's baseline voice waveform is not acceptable, CVA program 107 augments the user's current voice waveform using a trained generative AI voice model. The AI voice model may be the generative AI voice model trained, by CVA program 107 in cognitive voice amelioration initialization process 200, to produce speech which mimics the voice and speaking style of the user. According to at least one embodiment, CVA program 107 may augment, via the trained generative AI voice model, the segment of the user's speech output corresponding to their current voice waveform being transmitted during the online call. The trained generative AI voice model may utilize a running transcript, generated and maintained by CVA program 107, of the user's speech utterances during the online conference call as input when augmenting the segment of the user's speech output corresponding to their current voice waveform. According to at least one other embodiment, CVA program 107 may augment, via the trained generative AI voice model, one or more frequency components of the user's current voice waveform being transmitted during the online call. In such an embodiment, augmentation of one or more frequency components of the user's current voice waveform may include alignment, by CVA program 107, of frequency components of the user's current voice waveform with corresponding frequency components of the user's baseline voice waveform and/or the user's optimal voice waveform (e.g., adjusting one or more frequency components to match corresponding frequency components of the baseline voice waveform or to fall within a range of accepted or defined frequency components).

According to at least one further embodiment, where results of a performed microphone performance test or a performed network connection test fail or fall below minimum threshold values, or where a calculated PESQ score falls below a threshold value, CVA program 107 may substitute the user's speech during the online conference call using the trained generative AI voice model. For example, if a microphone test indicates that the microphone is not able to capture audio of the user, or if one or more resulting metrics of a network connection test fall below corresponding threshold values, CVA program 107 may receive text input from the user while participating in the online conference call and provide the received text input to the trained generative AI voice model for speech output, in the voice and speaking style of the user, via TTS synthesis. In embodiments of the invention, CVA program 107 may notify the user (e.g., via a text notification or icon display within the online conference application) of any user speech augmentation or substitution being performed by CVA program 107.

It may be appreciated that FIGS. 2 and 3 provide only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
identifying a current voice waveform of a user, wherein the current voice waveform corresponds to captured speech output of the user;
comparing one or more frequency components of the current voice waveform to one or more corresponding frequency components of a baseline voice waveform of the user; and
in response to determining that at least one of the one or more frequency components of the current waveform fail a threshold degree of match to at least one corresponding frequency component of the baseline voice waveform, augmenting the captured speech output via a generative artificial intelligence (AI) voice model trained to produce speech which mimics a voice and a speaking style of the user.

2. The method of claim 1, further comprising:
training the generative AI voice model using a corpus of user-specific training material which comprises a plurality of audio recordings and corresponding text transcriptions of the user; and
identifying the baseline voice waveform of the user based on spectrogram analysis of the plurality of audio recordings of the user-specific training material, wherein the baseline voice waveform comprises a plurality of baseline frequency components.

3. The method of claim 2, wherein the baseline voice waveform of the user represents averages of individual frequency components within the audio recordings of the user-specific training material.

4. The method of claim 1, wherein the captured speech output of the user is captured via a microphone of a computing device of the user during participation by the user in an online conference call.

5. The method of claim 4, further comprising:
evaluating a current network connection of the computing device to identify one or more current network metrics;
comparing the one or more current network metrics with one or more specified corresponding minimum threshold values; and
in response to determining that at least one of the one or more current network metrics falls below at least one specified corresponding minimum threshold value, augmenting the captured speech output via the generative AI voice model trained to produce speech which mimics a voice and a speaking style of the user.

6. The method of claim 4, further comprising:
prior to participation by the user in the online conference call, evaluating a network connection and microphone performance of the computing device; and
in response to a detected microphone failure or in response metrics of the network connection being below minimum threshold values, substituting speech output of the user during the online conference call via the generative AI voice model, wherein the substituting comprises:
receiving text input from the user while participating in the online conference call; and
providing the received text input to the generative AI voice model for speech output, in a voice and speaking style of the user, via text-to-speech synthesis.

7. The method of claim 1, further comprising:
in response to determining that at least one of the one or more frequency components of the current waveform fail a threshold degree of match to at least one corresponding frequency component of the baseline voice waveform, augmenting at least one of the one or more frequency components of the current waveform via the generative AI voice model, wherein the augmenting comprises aligning at least one of the one or more frequency components of the current waveform with at least one corresponding frequency component of the baseline voice waveform.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a current voice waveform of a user, wherein the current voice waveform corresponds to captured speech output of the user;
comparing one or more frequency components of the current voice waveform to one or more corresponding frequency components of a baseline voice waveform of the user; and
in response to determining that at least one of the one or more frequency components of the current waveform fail a threshold degree of match to at least one corresponding frequency component of the baseline voice waveform, augmenting the captured speech output via a generative artificial intelligence (AI) voice model trained to produce speech which mimics a voice and a speaking style of the user.

9. The computer system of claim 8, the method further comprising:
training the generative AI voice model using a corpus of user-specific training material which comprises a plurality of audio recordings and corresponding text transcriptions of the user; and
identifying the baseline voice waveform of the user based on spectrogram analysis of the plurality of audio recordings of the user-specific training material, wherein the baseline voice waveform comprises a plurality of baseline frequency components.

10. The computer system of claim 9, wherein the baseline voice waveform of the user represents averages of individual frequency components within the audio recordings of the user-specific training material.

11. The computer system of claim 8, wherein the captured speech output of the user is captured via a microphone of a computing device of the user during participation by the user in an online conference call.

12. The computer system of claim 11, the method further comprising:
evaluating a current network connection of the computing device to identify one or more current network metrics;
comparing the one or more current network metrics with one or more specified corresponding minimum threshold values; and
in response to determining that at least one of the one or more current network metrics falls below at least one specified corresponding minimum threshold value, augmenting the captured speech output via the generative AI voice model trained to produce speech which mimics a voice and a speaking style of the user.

13. The computer system of claim 11, the method further comprising:
prior to participation by the user in the online conference call, evaluating a network connection and microphone performance of the computing device; and
in response to a detected microphone failure or in response metrics of the network connection being below minimum threshold values, substituting speech output of the user during the online conference call via the generative AI voice model, wherein the substituting comprises:
receiving text input from the user while participating in the online conference call; and
providing the received text input to the generative AI voice model for speech output, in a voice and speaking style of the user, via text-to-speech synthesis.

14. The computer system of claim 8, the method further comprising:
in response to determining that at least one of the one or more frequency components of the current waveform fail a threshold degree of match to at least one corresponding frequency component of the baseline voice waveform, augmenting at least one of the one or more frequency components of the current waveform via the generative AI voice model, wherein the augmenting comprises aligning at least one of the one or more frequency components of the current waveform with at least one corresponding frequency component of the baseline voice waveform.

15. A computer program product, the computer program product comprising:
one or more computer-readable tangible storage medium and program instructions stored on at least one of the one or more tangible storage medium, the program instructions executable by a processor capable of performing a method, the method comprising:
identifying a current voice waveform of a user, wherein the current voice waveform corresponds to captured speech output of the user;
comparing one or more frequency components of the current voice waveform to one or more corresponding frequency components of a baseline voice waveform of the user; and
in response to determining that at least one of the one or more frequency components of the current waveform fail a threshold degree of match to at least one corresponding frequency component of the baseline voice waveform, augmenting the captured speech output via a generative artificial intelligence (AI) voice model trained to produce speech which mimics a voice and a speaking style of the user.

16. The computer program product of claim 15, the method further comprising:
training the generative AI voice model using a corpus of user-specific training material which comprises a plurality of audio recordings and corresponding text transcriptions of the user; and
identifying the baseline voice waveform of the user based on spectrogram analysis of the plurality of audio recordings of the user-specific training material, wherein the baseline voice waveform comprises a plurality of baseline frequency components.

17. The computer program product of claim 16, wherein the baseline voice waveform of the user represents averages of individual frequency components within the audio recordings of the user-specific training material.

18. The computer program product of claim 15, wherein the captured speech output of the user is captured via a microphone of a computing device of the user during participation by the user in an online conference call.

19. The computer program product of claim 18, the method further comprising:
evaluating a current network connection of the computing device to identify one or more current network metrics;
comparing the one or more current network metrics with one or more specified corresponding minimum threshold values; and
in response to determining that at least one of the one or more current network metrics falls below at least one specified corresponding minimum threshold value, augmenting the captured speech output via the generative AI voice model trained to produce speech which mimics a voice and a speaking style of the user.

20. The computer program product of claim 18, the method further comprising:
prior to participation by the user in the online conference call, evaluating a network connection and microphone performance of the computing device; and
in response to a detected microphone failure or in response metrics of the network connection being below minimum threshold values, substituting speech output of the user during the online conference call via the generative AI voice model, wherein the substituting comprises:
receiving text input from the user while participating in the online conference call; and
providing the received text input to the generative AI voice model for speech output, in a voice and speaking style of the user, via text-to-speech synthesis.
